(19) United States
(12) Patent Application Publication
(10) Pub. No.: US 2009/0167744 A1
(43) Pub. Date: Jul. 2, 2009

(54) ELECTRO-OPTICAL DEVICE AND ELECTRONIC APPARATUS PROVIDED WITH THE SAME

(75) Inventor: Hiroyuki HORIBATA, Gifu-shi (JP)

Correspondence Address: OLIFF & BERRIDGE, PLC, P.O. BOX 320850, ALEXANDRIA, VA, 22320-4850, US

(73) Assignee: EPSON IMAGING DEVICES CORPORATION, Azumino-shi (JP)

(21) Appl. No.: 12/259,023

(22) Filed: Oct. 27, 2008

(30) Foreign Application Priority Data
Dec. 26, 2007 (JP) 2007-333902

(51) Int. Cl. G09G 5/00; G09G 3/36

(52) U.S. Cl. 345/211; 345/90

(57) ABSTRACT

An electro-optical device includes pixels and a power supply circuit. The pixels are provided at positions corresponding to intersections of a plurality of scanning lines and a plurality of data lines. Each of the pixels includes a pixel switching element that is connected to a corresponding one of the data lines, a corresponding one of the scanning lines and a pixel electrode. When the scanning line connected to the pixel switching element is selected, the corresponding pixel electrode enters a conductive state with a corresponding one of the data lines. The power supply circuit generates a power supply electric potential for controlling on/off of each pixel switching element. The power supply circuit includes a discharging resistance that has a resistance value such that an electric current that is sufficiently smaller in comparison with the feeding capability of the power supply circuit in a steady state flows through an output portion of the power supply electric potential.

### BACKGROUND

1. Technical Field

The present invention relates to an electro-optical device that includes a power supply circuit that generates a power supply electric potential for controlling on/off of a pixel transistor, and an electronic apparatus provided with the electro-optical device.

2. Related Art

In an existing active matrix liquid crystal display device that is manufactured through low-temperature polysilicon TFT (Thin Film Transistor) process, in order to reduce the cost of a driving signal IC, a power supply circuit that generates a power supply electric potential is formed on a TFT substrate of a liquid crystal panel for controlling on/off of a pixel TFT, which is, for example, described in JP-A-2004-146082.

Incidentally, in the liquid crystal display, when a power supply circuit is formed in the panel, the power supply electric potential (for turning off the gate) of a power supply line is not discharged to a pixel TFT and, therefore, electric charge that is charged in the pixel continues to be held. This problematically creates an afterimage. In addition, because the power supply electric potentials (for turning on the gate and for turning off the gate) of a power supply line are not discharged to a pixel TFT, stress continues to be applied to a driver IC or a transistor in the panel. This may cause inconvenience.

As measures to the afterimage or to the inconvenience due to residual electric charge, in a low-temperature polysilicon power supply circuit, electric charge is discharged by turning on a discharging transistor (discharge transistor) using a control signal from an IC. In this case, however, if a situation that no control signal is output from the IC, such as a disconnection of the battery of a cellular phone, or the like, or an unexpected interruption of power supply, occurs, the discharge transistor cannot turn on and, as a result, cannot discharge electric charge.

### SUMMARY

An advantage of some aspects of the invention is that it provides an electro-optical device that is able to discharge a power supply electric potential without using an external control signal, and an electronic apparatus that is provided with the electro-optical device.

A first aspect of the invention provides an electro-optical device. The electro-optical device includes pixels and a power supply circuit. The pixels are provided at positions corresponding to intersections of a plurality of scanning lines and a plurality of data lines. Each of the pixels includes a pixel switching element that is connected to a corresponding one of the data lines, a corresponding one of the scanning lines and a pixel electrode. When the scanning line connected to the pixel switching element is selected, the corresponding pixel electrode enters a conductive state with a corresponding one of the data lines. The power supply circuit generates a power supply electric potential for controlling on/off of each pixel switching element. The power supply circuit includes a discharging resistance that has a resistance value such that an electric current that is sufficiently smaller in comparison with the feeding capability of the power supply circuit in a steady state flows through an output portion of the power supply electric potential.

With the above configuration, because the power supply electric potential may be discharged without requiring an external control signal, even when a situation that no above control signal is output occurs, it is possible to suppress the occurrence of an afterimage by discharging electric charge that is charged in a pixel and, therefore, it is possible to suppress the occurrence of inconvenience due to residual electric charge. In addition, because the resistance value of the discharging resistance is set to a value such that an electric current that is sufficiently smaller in comparison with the feeding capability of the power supply circuit in a steady state flows, it does not adversely affects power consumption of the module overall, and it is possible to discharge electric charge that is charged in the output capacitor of the power supply circuit at the time a normal operation ends and after a predetermined time has elapsed.

In addition, a second aspect of the invention may be configured, in the first aspect of the invention, so that the power supply circuit includes a positive power supply generating circuit that generates a positive power supply electric potential, and one end of the discharging resistance is connected to an output node of the positive power supply generating circuit, while the other end is connected to a ground electric potential. With the above configuration, it is possible to generate a positive power supply electric potential that is suitable for turning on a pixel switching element by the positive power supply generating circuit, and it is possible to reliably discharge the positive power supply electric potential, which is generated by the positive power supply generating circuit, to a ground level.

Furthermore, a third aspect of the invention may be configured, in the first or second aspect of the invention, so that the power supply circuit includes a negative power supply generating circuit that generates a negative power supply electric potential, and one end of the discharging resistance is connected to an output node of the negative power supply generating circuit, while the other end is connected to a ground electric potential. With the above configuration, it is possible to generate a negative power supply electric potential that is suitable for turning off a pixel switching element by the negative power supply generating circuit, and it is possible to reliably discharge the negative power supply electric potential, which is generated by the negative power supply generating circuit, to a ground level.

In addition, a fourth aspect of the invention may be configured, in the second aspect of the invention, so that the positive power supply generating circuit and the discharging resistance are formed on the same substrate as the pixels. With the above configuration, because the discharging resistance is formed in the panel, it is not necessary to provide an external resistance on an FPC, or the like. Thus, neither the number of components nor the number of terminals increases and, as a result, the costs may be reduced by that much.

Furthermore, a fifth aspect of the invention may be configured, in the third aspect of the invention, so that the negative power supply generating circuit and the discharging resistance are formed on the same substrate as the pixels. With the above configuration, because the discharging resistance is formed in the panel, it is not necessary to provide an external resistance on an FPC, or the like. Thus, neither the number of components nor the number of terminals increases and, as a result, the costs may be reduced by that much.

Furthermore, a sixth aspect of the invention provides an electronic apparatus that is provided with the electrooptical device according to any one of the first to fifth aspects of the invention. With the above configuration, because the power supply electric potential of the power supply circuit may be reliably discharged, the occurrence of an afterimage is suppressed and, therefore, an excellent electronic apparatus may be provided.

### BRIEF DESCRIPTION OF THE DRAWINGS

The invention will be described with reference to the accompanying drawings, wherein like numbers reference like elements.

FIG. 1 is a block diagram that shows the configuration of an electro-optical device according to an embodiment of the invention.

FIG. 2 is a waveform chart of a common electrode signal.

FIG. 3 is a block diagram that shows a schematic configuration of a power supply circuit according to a first embodiment.

FIG. 4 is a circuit diagram that shows the configuration of a positive power supply generating circuit.

FIG. 5 is a circuit diagram that shows the configuration of a negative power supply generating circuit.

FIG. 6 is a block diagram that shows a schematic configuration of a power supply circuit according to a second embodiment.

FIG. 7 is a circuit diagram that shows another example of a positive power supply generating circuit.

FIG. 8 is a circuit diagram that shows another example of a positive power supply generating circuit.

### DESCRIPTION OF EXEMPLARY EMBODIMENTS

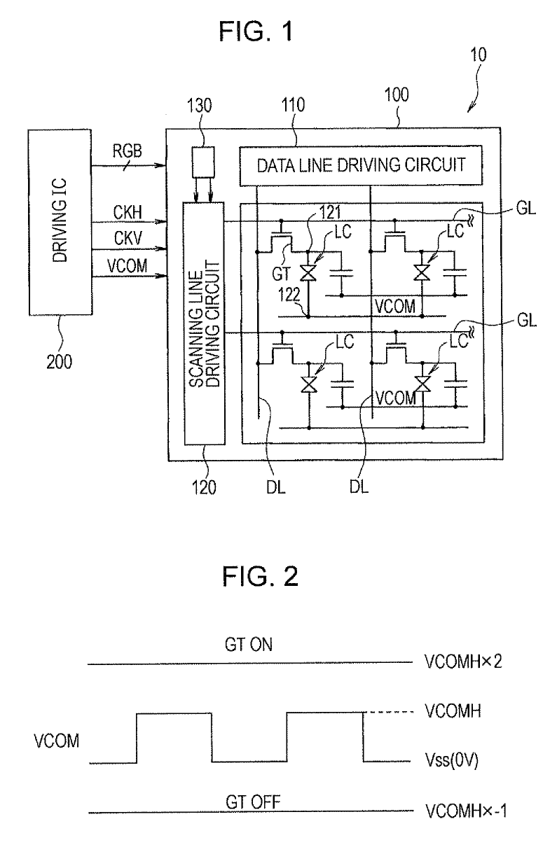

Hereinafter, an embodiment of the invention will be described with reference to the accompanying drawings. FIG. 1 is a block diagram that shows the configuration of an electro-optical device 10 according to a first embodiment of the invention. As shown in the drawing, the electro-optical device 10 includes a liquid crystal panel 100. On a TFT substrate of the liquid crystal panel 10, a data line driving circuit 110, a scanning line driving circuit 120 and a display area are formed, and a plurality of pixels (four pixels are shown in FIG. 1) are arranged in the display area in a matrix. The data line driving circuit 110 is a shift register that sequentially transfers a horizontal start signal on the basis of a horizontal transfer clock CKH, and supplies an image signal of RGB to each data line DL in accordance with the output of the horizontal start signal. The scanning line driving circuit 120 is a shift register that sequentially transfers a vertical start signal on the basis of a vertical transfer clock CKV, and supplies a gate signal to each gate line GL in accordance with the output of the vertical start signal.

The drain of a pixel transistor GT, formed of a TFT, in each pixel is connected to a corresponding one of the data lines DL, and the on/off of the pixel transistor GT is controlled through a gate signal. The source of the pixel transistor GT is connected to a pixel electrode 121. In addition, an opposite substrate is provided so as to face the TFT substrate, and a common electrode 122 is formed on the opposite substrate so as to face the pixel electrodes 121. A liquid crystal LC is sealed between the TFT substrate and the opposite substrate. Furthermore, as shown in FIG. 2, the common electrode 122 is applied with a common electrode signal VCOM that alternately repeats an H level and an L level for each horizontal period or a driving IC 200 provided outside of the liquid crystal panel 100 or on the TFT substrate of the liquid crystal panel 100 in order to perform line inversion driving.

When each pixel transistor GT is of an n-channel type, as the gate signal attains an H level, the pixel transistor GT turns on. By so doing, an image signal is applied from the data line DL through the pixel transistor GT to the pixel electrode 121, and the liquid crystal LC is aligned by an electric field generated between the common electrode 122 and the pixel electrode 121. Thus, liquid crystal display is performed. Here, because the common electrode signal VCOM alternately repeats an H level and an L level, the electric potential of each pixel electrode 121 varies due to a capacitive coupling via the liquid crystal LC. Then, in order to cause the pixel transistor GT to turn on, the H level of the gate signal needs to be an electric potential that is sufficiently higher than the maximum electric potential of an image signal written to the data line. Thus, in order to cause the pixel transistor GT to turn off, the L level of the gate signal needs to be an electric potential that is sufficiently lower than the minimum electric potential of the pixel. Here, VCOMH is about 4.5 V.

In the electro-optical device according to the present embodiment, the H level of the gate signal needs to be a positive power supply electric potential that is obtained by multiplying two by the amplitude of VCOMH, that is, VCOMH×2, and the L level of the gate signal needs to be a negative power supply electric potential that is obtained by multiplying minus one by the amplitude of VCOMH, that is VCOMH×−1 In order to generate such a gate signal, a power supply circuit 130 is formed on the TFT substrate of the liquid crystal panel 100 through a system on glass (SOG) technology by which a peripheral circuit is formed on a glass substrate through TFT process, and the output of the power supply circuit 130 is supplied to the scanning line driving circuit 120.

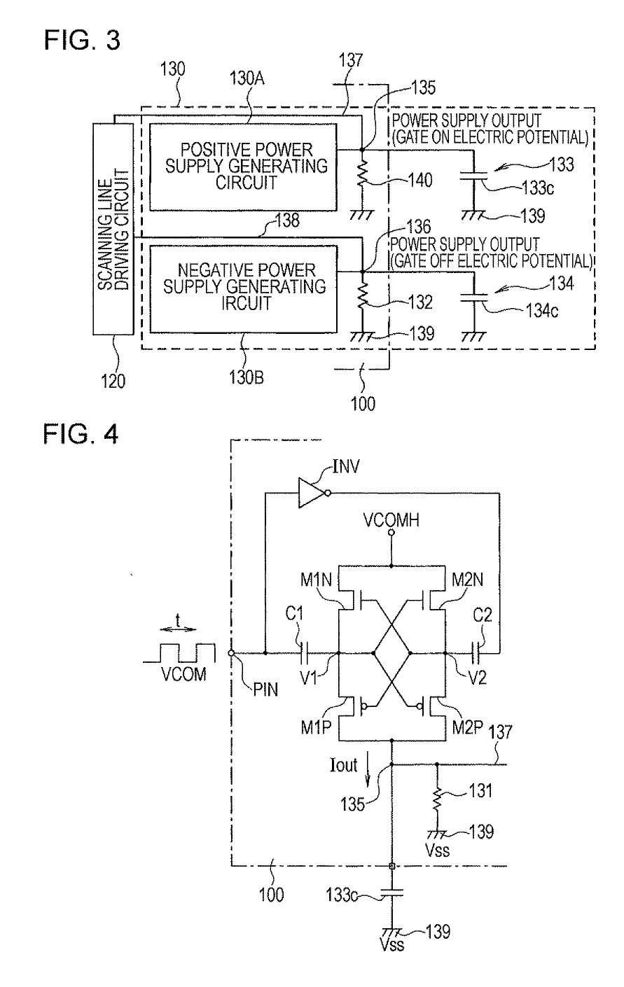

FIG. 3 is a block diagram that shows a schematic configuration of the power supply circuit 130. As shown in FIG. 3, the power supply circuit 130 includes a DC-DC converter (positive power supply generating circuit) 130A that generates a positive power supply electric potential, a DC-DC converter (negative power supply generating circuit) 130B that generates a negative power supply electric potential, output portions 133 and 134 formed of smoothing output capacitors 133C and 134C, respectively, and discharging resistances 131 and 132 that are connected in parallel with the output portions 133 and 134, respectively. In the present embodiment, the common electrode signal VCOM is used as a driving signal for these DC-DC converters.

The smoothing output capacitors 133C and 134C are connected between an output node (terminal) 135 of the positive power supply generating circuit 130A and a ground line 139 and between an output node 136 of the negative power supply generating circuit 130B and the ground line 139, and the discharging resistances 131 and 132 are connected in parallel with these output capacitors 133C and 134C. The ground line 139 is set for a ground electric potential (0 V) of a ground level, which is a reference electric potential. In addition, the reference numerals 137 and 138 denote power supply lines, both of which supply the scanning line driving circuit 120 with a power supply electric potential,

That is, one end of the discharging resistance 131 is connected to the output node of a positive power supply electric potential (gate on electric potential), and the other end is connected to the ground electric potential (0 V). In addition, one end of the discharging resistance 132 is connected to the output node of a negative power supply electric potential (gate off electric potential), and the other end is connected to the ground electric potential (0 V). Note that the discharging resistances 131 and 132 are formed on the TFT substrate of the liquid crystal panel 100 through SOG technology, while, on the other hand, the output capacitors 133C and 134C are formed of an external capacitor outside the liquid crystal panel 100 because of their large areas.

The resistance values of these discharging resistances 131 and 132 are relatively large, and electric current regularly flows in a steady state; however, the resistance values are set to a value (for example, 1 MΩ) that is sufficiently smaller in comparison with the feeding capability of the power supply circuit 130 and that does not cause a decrease in output electric potential. Here, an electric current (steady state current) Ir that regularly flows through the discharging resistances 131 and 132 even in a steady state will be Ir=Vout/R, where the output electric potential of the power supply circuit 130 is Vout, and the resistance value is R. For example, in a case where the output electric potential of the positive power supply generating circuit 130A is 8.5 V, when the resistance of 1 MΩ is used as the discharging resistance 131, the steady state current Ir=8.5(V)/1 (MΩ)=8.5 (μA) will flow. Similarly, in a case where the output electric potential of the negative power supply generating circuit is −4.5 V, when the resistance of 1 MΩ is used as the discharging resistance 132, the steady state current Ir=4.5(V)/1 (MΩ)=4.5 (μA) will flow.

It is only necessary to set a discharging resistance value such that the steady state current Ir will be a sufficiently smaller value (smaller than or equal to about one-tenth of the whole) as compared with the feeding capability of the power supply circuit 130, that is, a consumption current (electric current that is supplied from the power supply circuit 130 to the scanning line driving circuit 120) of the liquid crystal panel, which is supplied from the power supply circuit 130.

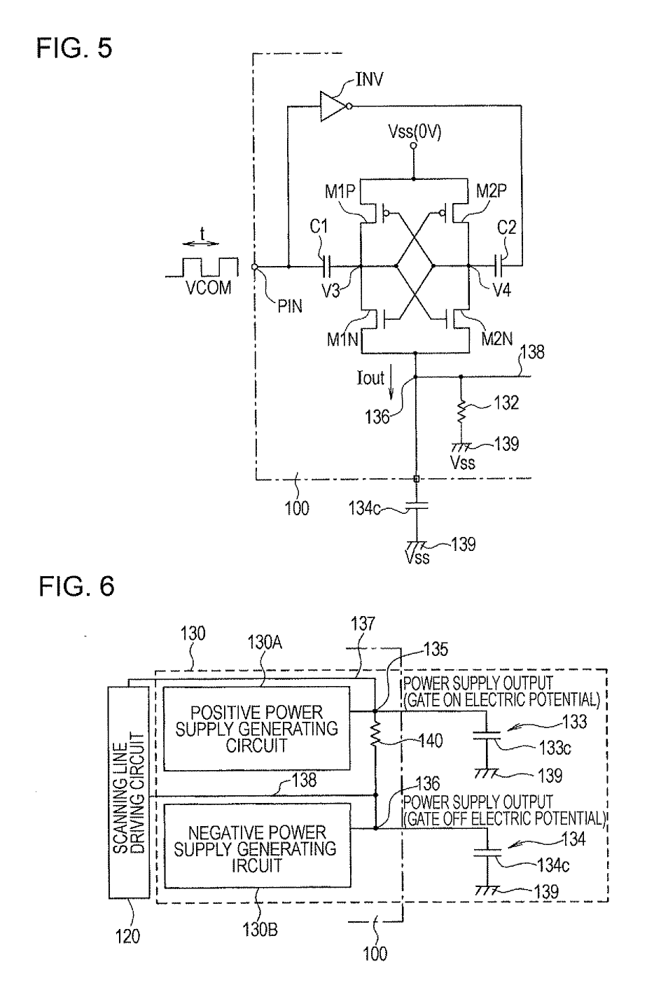

Next, the specific configuration of the positive power supply generating circuit 130A and negative power supply generating circuit 130B will be described. FIG. 4 is a circuit diagram of the positive power supply generating circuit 130A. FIG. 5 is a circuit diagram of the negative power supply generating circuit 130B. As shown in FIG. 4, the positive power supply generating circuit 130A is input with the common electrode signal VCOM through an input terminal PIN provided for the liquid crystal panel 100. Then, the input common electrode signal VCOM is input to one terminal of a first flying capacitor C1 and is inverted by an inverter INV. The inverted common electrode signal VCOM is input to one terminal of a second flying capacitor C2.

Here, the capacitance of the second flying capacitor C2 is preferably smaller than the capacitance of the first flying capacitor C1. In addition, an n-channel charge transfer transistor M1N and a p-channel charge transfer transistor M1P are connected in series with each other, and the gates of them are connected to the other terminal of the second flying capacitor C2. Furthermore, an n-channel charge transfer transistor M2N and a p-channel charge transfer transistor M2P are connected in series with each other, and the gates of them are connected to the other terminal of the first flying capacitor C1.

The other terminal of the first flying capacitor C1 is connected to the connecting point between the charge transfer transistor M1N and the charge transfer transistor M1P, and the other terminal of the second flying capacitor C2 is connected to the connecting point between the charge transfer transistor M2N and the charge transfer transistor M2P. The common source of the n-channel charge transfer transistors M1N and M2N is applied with VCOMH, which is an H level of the common electrode signal VCOM. When a voltage loss due to the transistor is ignored, a positive power supply electric potential, which is obtained by multiplying two by VCOMH, that is, VCOMH×2, and the output current Tout are output from the common drain of the p-channel charge transfer transistors M1P and M2P. Note that 133C denotes the smoothing output capacitor, and 131 denotes the discharging load resistance. In addition, each charge transfer transistor is formed of a TFT.

According to the above configuration, when the common electrode signal VCOM is at an H level, M1N and M2P turn off, M2N and M1P turn on, the electric potential V1 of the connection node between M1N and M1P is raised to VCOMH×2, and then the level of the electric potential V1 is output through M1P. At this timer the electric potential V2 of the connection node between M2N and M2P is charged to VCOMH. Next, when the common electrode signal VCOM attains an L level, M1N and M2P turn on, M2N and M1P turn off, the electric potential V2 is raised to VCOMH×2, and then the level of the electric potential V2 is output through M2P. At this time, the electric potential V1 is charged to VCOMH. That is, VCOMH×2 is alternately output from the right and left series transistor circuits of the DC-DC converter. However, a voltage loss due to the transistors is ignored.

In this manner, it is possible to create a gate signal (H level) that is suitable for turning on the pixel transistor GT. In addition, in the negative power supply generating circuit 130B, as shown in FIG. 5, the first flying capacitor C1 is applied with the common electrode signal VCOM, and the second flying capacitor C2 is applied with an inverted signal of the common electrode signal VCOM. The common source of M1P and M2P is applied with a ground electric potential Vss (0 V), and an electric potential that is obtained by multiplying minus one by VCOM, that is, VCOM×−1, is obtained from the common drain of M1N and M2N. Note that 134C denotes the smoothing output capacitor, and 132 denotes the discharging load resistance.

In this manner, it is possible to create a gate signal (L level) that is suitable for turning on the pixel transistor GT. The operation of the negative power supply generating circuit 130B will be described. When the common electrode signal VCOM is at an H level, M1N and M2P turn off, M2N and M1P turn on, the electric potential V3 of the connection node between M1N and M1P is charged to Vss, the electric potential V4 of the connection node between M2N and M2P is lowered to an electric potential of VCOMH×−1, and the electric potential V4 is output through M2N.

When the common electrode signal VCOM attains an L level, M1N and M2P turn on, M2N and M1P turn off, the electric potential V3 is lowered to VCOMH×−1, and the level of the electric potential V3 is output through M1N. At this time, the electric potential V4 is charged to Vss. That is, the electric potential of VCOMH×−1 is alternately output from the right and left series transistor circuits of the DC-DC converter. However, a voltage loss due to the transistor is ignored.

The above described electro-optical device 10 operates as follows. First, the power supply circuit 130 generates driving voltages (gate on electric potential and gate off electric potential) for setting scanning signals (gate signals) of the gate lines GL and supplies the driving voltages to the scanning line driving circuit 120. The scanning line driving circuit 120 generates an H-level gate signal and an L-level gate signal on the basis of the gate on electric potential and the gate off electric potential supplied from the power supply circuit 30. Then, by line-sequentially supplying the H-level gate signal to the gate lines GL, all the pixels in association with a predetermined gate line GL are selected.

In addition, in synchronization with the selection of the pixels, the data line driving circuit 110 supplies image signals to the respective data lines DL. In this manner, all the pixels selected by the scanning line driving circuit 120 are supplied with image signals, and then image data are written to the pixel electrodes 121. As the image data are written to the pixel electrodes 121, driving voltages are applied to the liquid crystals owing to differences in electric potential between the pixel electrodes 121 and the common electrode 122. Thus, by changing the voltage level of an image signal, alignment and/or order of the liquid crystal is varied to thereby make it possible to perform grayshade by means of light modulation of each pixel.

In the meantime, in the liquid crystal display; when the power supply circuit is formed in the panel, the power supply electric potential (for turning off the gate) of the power supply line is not discharged to a pixel TFT and, therefore, electric charge that is charged in the pixel continues to be held. This problematically creates an afterimage. In addition, because the power supply electric potentials (for turning on the gate and for turning off the gate) are not discharged, stress continues to be applied to a driver IC or a transistor in the panel. This may cause inconvenience.

As measures for inconvenience such as due to afterimage or residual electric charge, it is conceivable that a discharging transistor (discharge transistor) is turned on through a control signal from an IC to thereby discharge electric charge. In this case, however, if a situation that no control signal is output from the IC, such as a disconnection of the battery of a cellular phone, or the like, or an unexpected interruption of power supply, occurs, the discharge transistor cannot be turned on and, as a result, cannot discharge electric charge.

In contrast, in the present embodiment, the discharging resistances 131 and 132 are connected in parallel with the output portions 133 and 134 of the power supply circuit 130, respectively, so that without using an external control signal, it is possible to discharge electric charge that is charged in the output capacitors 133C and 134C. That is, in the power supply circuit 130, because the gate off electric potential for holding a pixel is discharged to a ground level, electric charge that is charged in the pixel tends to be easily discharged and, as a result, an afterimage may tend to disappear.

In addition, because the resistance values of the discharging resistances 131 and 132 are set so that an electric current that is sufficiently smaller in comparison with the feeding capability of the power supply circuit in a steady state flows and an output electric potential is not caused to decrease, the discharging resistances 131 and 132 do not adversely affect power consumption of the module overall. In this way, in the first embodiment, because the discharging resistances are connected to the output portions of the power supply circuit, no external control signal is necessary and discharging of the output capacitors of the power supply circuit is possible. Thus, even when a situation that no external control signal is input, such as a disconnection of the battery of a cellular phone, or the like, or an unexpected interruption of power supply, occurs, a power supply electric potential can be reliably discharged to discharge electric charge that is charged in a pixel. Thus, it is possible to improve display quality by suppressing the occurrence of an afterimage and it is possible to suppress degradation of the liquid crystal.

Furthermore, the discharging resistances are respectively connected between the output node of the positive power supply generating circuit and the ground electric potential and between the output node of the negative power supply generating circuit and the ground electric potential, so that the gate on electric potential and the gate off electric potential may be discharged to ground levels, respectively. In this manner, discharging of the power supply electric potentials (for turning on the gate and for turning off the gate) of the power supply lines 137 and 138 may be reliably performed, so that it is possible to suppress the occurrence of inconvenience due to stress being continuously applied to a driver IC and/or a transistor in the display panel.

Moreover, the discharging resistances are formed in the display panel, so that it is not necessary to provide an external resistance and, therefore, neither the number of components nor the number of terminals increases. Thus, the costs may be reduced by that much. Next, a second embodiment of the invention will be described.

In the above described first embodiment, the discharging resistances are respectively connected between the output node of the positive power supply generating circuit and the ground electric potential and between the output node of the negative power supply generating circuit and the ground electric potential; whereas in the second embodiment, a discharging resistance is connected in series with the output node of the positive power supply generating circuit and the output node of the negative power supply generating circuit.

FIG. 6 is a block diagram that shows a schematic configuration of the power supply circuit 130 according to the second embodiment. As shown in FIG. 6, the power supply circuit 130 of the present embodiment has the same configuration as the power supply circuit 130 of FIG. 3 except that a discharging resistance 140 is formed between the output node 135 of the positive power supply generating circuit 130A and the output node 136 of the negative power supply generating circuit 130B in place of the discharging resistances 131 and 132 shown in FIG. 3.

In this way, the discharging resistance 140 is formed to short-circuit the output nodes 135 and 136 of the positive power supply electric potential and negative power supply electric potential. At this time, if the capacitance of the output capacitor 133C of the positive power supply generating circuit 130A is equal to the capacitance of the output capacitor 134C of the negative power supply generating circuit 130B, the gate on electric potential and the gate off electric potential both are discharged to an intermediate electric potential ((VDD+VBB)/2) between the positive power supply electric potential (VDD) and the negative power supply electric potential (VBB). In this manner, as in the case of the above described first embodiment, it is possible to easily discharge electric charge that is charged in a pixel and, as a result, an afterimage problem may be solved.

In this way, in the second embodiment, because the discharging resistance is formed in series between the output node of the positive power supply generating circuit and the output node of the negative power supply generating circuit, it is not necessary to connect the discharging resistances to the respective output nodes of the power supply generating circuits. This can minimize a layout area for forming a discharging resistance.

Note that in the above embodiments, the positive power supply generating circuit 130A and the negative power supply generating circuit 130B are configured as shown in FIG. 4 and FIG. 5; instead, it is applicable that the common electrode signal VCOM is set as a driving signal, a positive power supply electric potential, which is VCOMH×2 as the gate on electric potential, and a negative power supply electric potential, which is VCOMH×−1 as the gate off electric potential, may be generated.

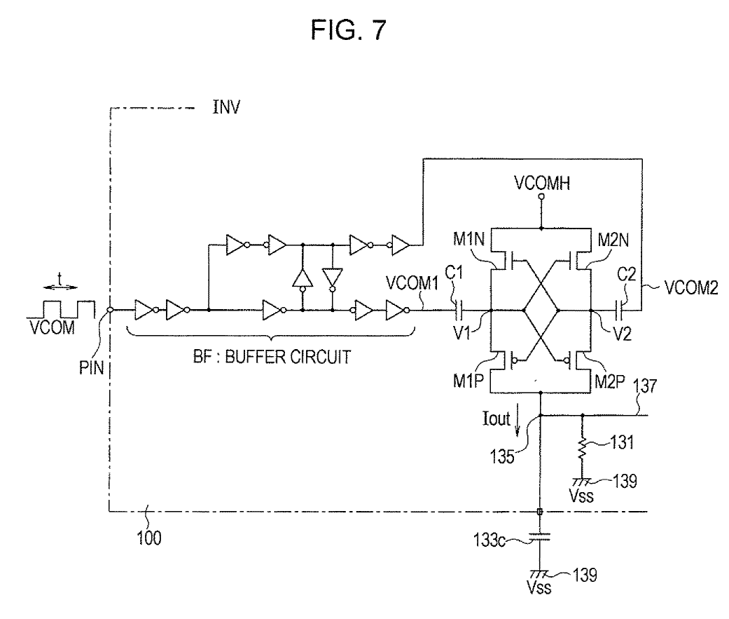

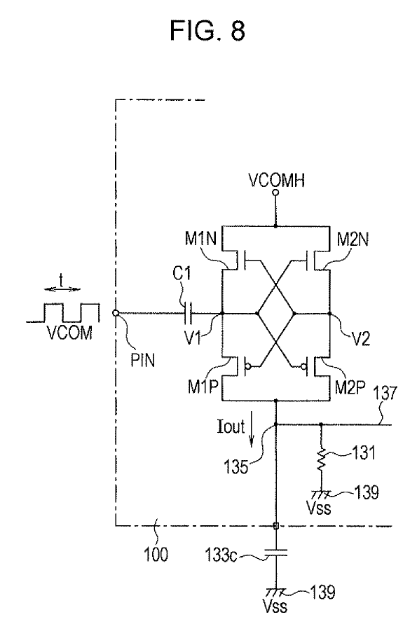

When described with the positive power supply generating circuit 130A, for example, as shown in FIG. 7, the common electrode signal VCOM may be input through a buffer circuit BF to one terminal of the first flying capacitor C1, or as shown in FIG. 8, the second flying capacitor C2 may be deleted, to thereby apply the common electrode signal VCOM to the first flying capacitor C1 only.

In addition, in the above embodiments, because the common electrode signal VCOM that is supplied to the common electrode 122 is also used as a driving signal, no exclusive output terminal is required for the driving IC 200. In addition, it is applicable that an exclusive driving signal is supplied from the driving IC 200 to the power supply circuit 130. In this case, an exclusive output terminal is required for the driving IC 200; however, a signal having a necessary and sufficient feeding capability is supplied from the driving IC 200 as an exclusive driving signal, so that no buffer circuit BF shown in FIG. 7 or no inverter INV for generating an inverted signal shown in FIG. 4 and FIG. 5 is necessary and, as a result, it is possible to reduce the circuit area of the power supply circuit 130.

In addition, in the above embodiments, the case in which the aspects of the invention are applied to the electro-optical device that uses the liquid crystal is described; instead, they may be applied to an electro-optical device that uses an electrooptic material other than the liquid crystal. For example, the aspects of the invention may be applied to various electro-optical devices, such as a display panel that uses an OLED element such as an organic EL or a light emitting polymer, as an electrooptic material, an electrophoretic display panel that uses a microcapsule that contains colored liquid and white particles dispersed in the liquid as an electrooptic material, a twisting ball display panel that uses a twisting ball painted into different colors for respective areas having different polarities as an electrooptic material, a toner display panel that uses a black toner as an electrooptic material, or a plasma display panel that uses high-pressure gas such as helium or neon as an electrooptic material.

In addition, in the electro-optical device of the above embodiments, the output capacitors 133C and 134C are formed of external capacitors outside the liquid crystal panel 100; instead, the output capacitors 133C and 134C may be formed through TFT process on the same substrate as the pixels. In this case, when the output capacitors 133C and 134C are formed by being laminated with a wire such as a ground line, the circuit area may be reduced. In addition, the electro-optical device of the above embodiments may be used as a display device that is mounted on an electronic apparatus. The electronic apparatus may specifically be a monitor, a television, a notebook personal computer, a PDA, a digital camera, a video camera, a cellular phone, a portable photo viewer, a portable video player, a portable DVD player, a portable audio player, or the like.

The entire disclosure of Japanese Patent Application No. 2007-333902, filed Dec. 26, 2007, is expressly incorporated by reference herein.

What is claimed is:

1. An electro-optical device comprising:
pixels that are provided at positions corresponding to intersections of a plurality of scanning lines and a plurality of data lines, wherein each of the pixels includes a pixel switching element that is connected to a corresponding one of the data lines, a corresponding one of the scanning lines and a pixel electrode, and wherein when the scanning line connected to the pixel switching element is selected, the corresponding pixel electrode enters a conductive state with a corresponding one of the data lines; and
a power supply circuit that generates a power supply electric potential for controlling on/off of each pixel switching element, wherein
the power supply circuit includes a discharging resistance that has a resistance value such that an electric current that is sufficiently smaller in comparison with the feeding capability of the power supply circuit in a steady state flows through an output portion of the power supply electric potential.

2. The electro-optical device according to claim 1, wherein the power supply circuit includes a positive power supply generating circuit that generates a positive power supply electric potential, and wherein one end of the discharging resistance is connected to an output node of the positive power supply generating circuit, while the other end is connected to a ground electric potential.

3. The electrooptical device according to claim 1, wherein the power supply circuit includes a negative power supply generating circuit that generates a negative power supply electric potential, and wherein one end of the discharging resistance is connected to an output node of the negative power supply generating circuit, while the other end is connected to a ground electric potential.

4. The electro-optical device according to claim 1, wherein the power supply circuit include a positive power supply generating circuit that generates a positive power supply electric potential and a negative power supply generating circuit that generates a negative power supply electric potential, and wherein one end of the discharging resistance is connected to an output node of the positive power supply generating circuit, while the other end is connected to the negative power supply generating circuit.

5. The electro-optical device according to claim 2, wherein the positive power supply generating circuit and the discharging resistance are formed on the same substrate as the pixels.

6. The electro-optical device according to claim 3, wherein the negative power supply generating circuit and the discharging resistance are formed on the same substrate as the pixels.

7. The electro-optical device according to claim 4, wherein the positive power supply generating circuit and the negative power supply generating circuit are formed on the same substrate as the pixels.

8. The electro-optical device according to claim 1, wherein the discharging resistance has a resistance value such that an electric current that is sufficiently smaller in comparison with the feeding capability of the power supply circuit in a steady state flows through an output portion of the power supply electric potential.

9. The electro-optical device according to claim 1, wherein the discharging resistance has a resistance value such that an electric current that is smaller than or equal to about one-tenth of the whole in comparison with the feeding capability of the power supply circuit in the steady state flows through an output portion of the power supply electric potential.

10. An electronic apparatus comprising the electro-optical device according to claim 1.
